(19) United States
(12) Patent Application Publication
(10) Pub. No.: US 2025/0382533 A1
(43) Pub. Date: Dec. 18, 2025

(54) AN AVIATION FUEL COMPONENT

(71) Applicant: Neste Oyj, Espoo (FI)

(72) Inventors: Jesse VILJA, Porvoo (FI); Kati SANDBERG, Porvoo (FI); Kaisa LAMMINPÄÄ, Porvoo (FI); Ulla KIISKI, Porvoo (FI); Petro SIREGAR, née SILVONEN, Porvoo (FI)

(73) Assignee: Neste Oyj, Espoo (FI)

(21) Appl. No.: 18/876,309

(22) PCT Filed: Jun. 30, 2023
(86) PCT No.: PCT/FI2023/050413

§ 371 Date: Dec. 18, 2024

(30) Foreign Application Priority Data
Jun. 30, 2022 (FI) 20225603
Jun. 30, 2022 (FI) 20225604
Jun. 30, 2022 (FI) 20225605
Jun. 30, 2022 (FI) 20225606
Jun. 30, 2022 (FI) 20225607
Jun. 30, 2022 (FI) 20225608
Jun. 30, 2022 (FI) 20225609
Dec. 2, 2022 (FI) 20226071
Jun. 20, 2023 (FI) 20235691

(51) Int. Cl. C10G 65/12

(52) U.S. Cl. CPC C10G 65/12; C10G 2300/1081; C10G 2300/301; C10G 2300/302; C10G 2400/08

(57) ABSTRACT

Herein is disclosed an aviation fuel component including predominantly C6-C18 n-paraffins, C6-C18 mono-branched i-paraffins, and C6-C18 multiple-branched i-paraffins. The aviation fuel component has a very high isomerization degree and relatively broad carbon number distribution. The present aviation fuel component is particularly useful in aviation fuels, wherein it can be incorporated even in very high proportions.

### TECHNICAL FIELD

The present disclosure generally relates to processes producing fuel components and products thereof. The disclosure relates particularly, though not exclusively, to an aviation fuel component obtainable from renewable feed.

### BACKGROUND

This section illustrates useful background information without admission of any technique described herein representative of the state of the art.

There is an ongoing need to reduce greenhouse gas emissions and/or carbon footprint in transportation, especially aviation. Accordingly, interest towards renewable aviation fuels and aviation fuel components is and has been growing.

Processes for producing aviation fuel components from renewable raw materials have been proposed. However, the yield of aviation fuel components (compared to other fuel components) has been relatively low in said processes. Also, there is a need to improve quality of renewable aviation fuel components. Particularly, there is an interest towards producing aviation fuel components that could be used in aviation fuels in elevated amounts, or when suitably additized even as such as an aviation fuel.

### SUMMARY

It is an aim to solve or alleviate at least some of the problems related to prior art. An aim is to improve the quality of aviation fuel components obtainable from renewable sources.

The appended claims define the scope of protection. Any examples and technical descriptions of products, processes, and/or uses in the description and/or drawings not covered by the claims are presented as examples useful for understanding the invention.

According to a first example aspect, there is provided an aviation fuel component, comprising n-paraffins, monobranched i-paraffins and multiple-branched i-paraffins, wherein the sum amount of C6-C18 n-paraffins, C6-C18 monobranched i-paraffins and C6-C18 multiple-branched i-paraffins is at least 90 wt-%, preferably at least 93 wt-%, more preferably at least 95 wt-%, even more preferably at least 96 wt-% of the total aviation fuel component weight, and wherein the weight ratio of C6-C18 multiple-branched i-paraffins to C6-C18 n-paraffins is at least 10, and wherein the aviation fuel component has T10 and T90 temperatures, as determined according to EN ISO 3405-2019, within a range from 120 to 295° C., preferably within a range from 130 to 295° C.

The inventors have found the present aviation fuel component and embodiments thereof to provide certain advantages compared to prior art aviation fuel components The advantages are related e.g to surprisingly good cold properties compared to prior art aviation fuel products. Said advantages are believed to be contributed by the chemical composition of the present aviation fuel component, at least by a high isomerization degree, especially by the high content of multiple-branched isoparaffins.

Production of the aviation fuel component may employ a certain process comprising a combination of hydroisomerisation and hydrocracking of a paraffinic feed. The present aviation fuel component may be obtained from a process for producing renewable fuel components further comprising recovery of gasoline and/or diesel fuel components.

According to a second example aspect, there is provided an aviation fuel composition comprising the aviation fuel component as defined herein, preferably in an amount from 1 vol-% to 99.5 vol-%, preferably from 5 vol-% to 95 vol-%, more preferably from 10 vol-% to 70 vol-% of the total aviation fuel composition volume. Surprisingly high-volume share, even 99.5 vol-% of the aviation fuel component in the aviation fuel composition, may be possible particularly due to the exceptionally good cold properties and sufficient density of the present aviation fuel component.

According to a third example aspect there is provided use of an aviation fuel component as defined herein in an aviation fuel composition for improving one or more product properties of the aviation fuel composition.

According to a fourth example aspect there is provided use of an aviation fuel component as defined herein in solvent(s), in carrier(s), in dispersant composition(s), in demulsifier(s), in extractant(s), in detergent(s), in degreasing composition(s), in cleaner(s), in thinner(s), in penetrating oil(s), in anticorrosion composition(s), in multipurpose oil(s), in metal working fluid(s), in rolling oil(s) especially for aluminium, in cutting oil(s), in drilling fluid(s), in lubricant(s), in extender oil(s), in paint composition(s), in coating fluid(s) or paste(s), in adhesive(s), in resin(s), in varnish(es), in printing paste(s) or ink(s), in plasticizing oil(s), in turbine oil(s), in hydrophobization composition(s), in agriculture, in crop protection fluid(s), in construction, in concrete demoulding formulation(s), in electronics, in medical appliance(s), in feedstock(s) for industrial conversion process(es), preferably in thermal cracking feedstock(s) and/or in catalytic cracking feedstock(s), in composition(s) for car, electrical, textile, packaging, paper and/or pharmaceutical industry, and/or in manufacture of intermediate(s) therefor. In said use(s) the excellent physico-chemical characteristics may be utilised and at the same time renewable character may be appreciated.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 illustrates schematically an example embodiment of a process for producing the present aviation fuel component.

FIG. 2 illustrates schematically another example embodiment of a process for producing the present aviation fuel component.

### DETAILED DESCRIPTION

In the following description, like reference signs denote like elements or steps.

All standards referred to herein are the latest revisions available at the filing date, unless otherwise mentioned.

Unless otherwise stated, regarding distillation characteristics, such as initial boiling points (IBP), final boiling points (FBP), T10 temperature (10 vol-% recovered), T90 temperature (90 vol-% recovered), and boiling ranges, reference is made to EN ISO 3405-2019. IBP is the temperature at the instant the first drop of condensate falls from the lower end of the condenser tube, and FBP is the maximum thermometer reading obtained during the test, usually occurring after the evaporation of all liquid from the bottom of the flask. For boiling point distribution reference may also be made to GC-based method (simdis) ASTM D2887-19e1, or for gasoline range hydrocarbons to ASTM D7096-19.

As used in the context of this disclosure, aviation fuel component refers to hydrocarbon compositions suitable for use in fuel compositions meeting standard specifications for aviation fuels, such as specifications laid down in ASTM D7566-21. Typically, such aviation fuel components boil, i.e. have IBP and FBP, within a range from about 100° C. to about 300° C., such as within a range from about 150° C. to about 300° C., as determined according to EN ISO 3405-2019.

As used in the context of this disclosure, diesel fuel component refers to hydrocarbon compositions suitable for use in fuel compositions meeting standard specifications for diesel fuels, such as specifications laid down in EN 590:2022 or in EN 15940:2016+A1:2018+AC:2019. Typically, such diesel fuel components boil, i.e. have IBP and FBP, within a range from about 160° C. to about 380° C., as determined according to EN ISO 3405-2019.

As used in the context of this disclosure, gasoline fuel component or naphtha refers to hydrocarbon components suitable for use in fuel compositions meeting standard specifications for gasoline fuels, such as specifications laid down in EN 228-2012+A1-2017. Typically, such gasoline fuel components boil, i.e. have IBP and FBP, within a range from about 25° C. to about 210° C., as determined according to EN ISO 3405-2019.

As used in the context of this disclosure, marine fuel component refers to hydrocarbon components suitable for use in fuel compositions meeting standard specifications for marine fuels, such as specifications laid down in ISO 8217-2017. Typically, such marine fuel components boil, i.e. have IBP and FBP, within a range from about 180° C. to about 600° C., such as from about 180° C. to about 400° C., as determined according to EN ISO 3405-2019.

As used herein hydrocarbons refer to compounds consisting of carbon and hydrogen. Hydrocarbons of particular interest in the present context comprise paraffins, n-paraffins, i-paraffins, monobranched i-paraffins, multiple-branched i-paraffins, olefins, naphthenes, and aromatics. Oxygenated hydrocarbons refer herein to hydrocarbons comprising covalently bound oxygen.

As used herein paraffins refer to non-cyclic alkanes, i.e. non-cyclic, open chain saturated hydrocarbons that are linear (normal paraffins, n-paraffins) or branched (isoparaffins, i-paraffins). In other words, paraffins refer herein to n-paraffins and/or i-paraffins.

In the context of the present disclosure, i-paraffins refer to branched open chain alkanes, i.e. non-cyclic, open chain saturated hydrocarbons having one or more alkyl side chains. Herein, i-paraffins having one alkyl side chain or branch are referred to as monobranched i-paraffins and i-paraffins having two or more alkyl side chains or branches are herein referred to as multiple-branched i-paraffins. In other words, i-paraffins refer herein to monobranched i-paraffins and/or multiple-branched i-paraffins. The alkyl side chain(s) may for example be C1-C9 alkyl side chain(s), preferably methyl side chain(s). The amounts of monobranched and multiple-branched i-paraffins may be given separately. The term “i-paraffins” refers to sum amount of any monobranched i-paraffins and multiple-branched i-paraffins, if present, indicating the total amount of any i-paraffins present regardless the number of branches. Correspondingly, “paraffins” refers to sum amount of any n-paraffins, any monobranched i-paraffins, and any multiple-branched i-paraffins, if present.

In the context of the present disclosure, olefins refer to unsaturated, linear, branched, or cyclic hydrocarbons, excluding aromatic compounds. In other words, olefins refer to hydrocarbons having at least one unsaturated bond, excluding unsaturated bonds in aromatic rings.

As used herein, cyclic hydrocarbons refer to all hydrocarbons containing cyclic structure(s), including cyclic olefins, naphthenes, and aromatics. Naphthenes refer herein to cycloalkanes i.e. saturated hydrocarbons containing at least one cyclic structure, with or without side chains. As naphthenes are saturated compounds, they are compounds without aromatic ring structure(s) present. Aromatics refer herein to hydrocarbons containing at least one aromatic ring structure, i.e. cyclic structure having delocalized, alternating π bonds all the way around said cyclic structure.

In the context of the present disclosure, for compositions boiling at 36° C. or higher (at standard atmospheric pressure), contents of n-paraffins, i-paraffins, monobranched i-paraffins, various multiple-branched isoparaffins, naphthenes, and aromatics are expressed as weight % (wt-%) relative to the degassed weight of the feed, stream, effluent, product, component or sample in question, or, when so defined, as weight % (wt-%) relative to the (total) weight of paraffins, or (total) weight of i-paraffins of the feed, stream, effluent, product, component, or sample in question. Said contents may be determined by GCxGC-FID/GCxGC-MS method, preferably conducted as follows: GCxGC (2D GC) method was run as generally disclosed in UOP 990-2011 and by Nousiainen M. in the experimental section of his Master's Thesis Comprehensive two-dimensional gas chromatography with mass spectrometric and flame ionization detectors in petroleum chemistry, University of Helsinki, August 2017, with the following modifications. The GCxGC was run in reverse mode, using a semipolar column (Rxi17Sil) first and a non-polar column (Rxi5Sil) thereafter, followed by FID detector, using run parameters: carrier gas helium 31.7 cm/sec (column flow at 40° C. 1.60 ml/min); split ratio 1:350; injector 280° C.; Column T program 40° C. (0 min)-5° C./min-250° C. (0 min)-10° C./min-300°° C. (5 min), run time 52 min; modulation period 10 sec; detector 300° C. with H2 40 ml/min and air 400 ml/min; makeup flow helium 30 ml/min; sampling rate 250 Hz and injection size 0.2 microliters. Individual compounds were identified using GCxGC-MS, with MS-parameters: ion source 230° C.; interface 300° C.; scan range 25-500 amu; event time (sec) 0.05; scan speed 20000. Commercial tools (Shimadzu's LabSolutions, Zoex's GC Image) were used for data processing including identification of the detected compounds or hydrocarbon groups, and for determining their mass concentrations by application of response factors relative to n-heptane to the volumes of detected peaks followed by normalization to 100 wt-%. Olefins were lumped with naphthenes and heteroatomic species with aromatics, unless separately reported. The limit of quantitation for individual compounds of this method is 0.1 wt-%.

In the context of the present disclosure, various characteristics of the feeds, streams, effluents, products, components, or samples are determined according to the standard methods referred to or disclosed herein, as properly prepared. For example, cloud point is determined according to ASTM D 5771-17 from a degassed feed, stream, effluent, product, component, or sample.

In the context of this disclosure, feed(s) to reaction sections, particularly to the first reaction section and/or the second reaction section, are defined so that H₂ possibly fed to the respective reaction section, for example H₂ fed to the hydroisomerisation and/or H₂ fed to the hydrocracking, is excluded from the definition of the feed(s).

As used herein, hydroisomerisation (HI) effluent refers to total HI effluent, degassed HI effluent, or degassed and stabilised HI effluent, as the case may be, and the term HI effluent may encompass each of these.

In the context of this disclosure, CX+ paraffins, CX+ n-paraffins, CX+ i-paraffins, mono-branched i-paraffins, CX+ multiple-branched i-paraffins, CX+ hydrocarbons, or CX+ fatty acids refer to paraffins, n-paraffins, i-paraffins, mono-branched i-paraffins, multiple-branched i-paraffins, hydrocarbons, or fatty acids, respectively, having a carbon number of at least X, where X is any feasible integer. It is understood that every compound falling within the definition is not necessarily present.

In the context of this disclosure, CY− paraffins, CY− n-paraffins, CY− i-paraffins, CY− mono-branched i-paraffins, CY− multiple-branched i-paraffins, CY− hydrocarbons, or CY− fatty acids refer to paraffins, n-paraffins, i-paraffins, mono-branched i-paraffins, multiple-branched i-paraffins, hydrocarbons, or fatty acids, respectively, having a carbon number of at most Y, wherein Y is any feasible integer. It is understood that every compound falling within the definition is not necessarily present.

In the context of this disclosure, CX_{Y}-CX_{Z} (or CX_{Y} to CX_{Z}) paraffins, CX_{Y}-CX_{Z} n-paraffins, CX_{Y}-CX_{Z} i-paraffins, CX_{Y}-CX_{Z} mono-branched i-paraffins, CX_{Y}-CX_{Z} multiple-branched i-paraffins, CX_{Y}-CX_{Z} hydrocarbons, or CX_{Y}-CX_{Z} fatty acids refer to a range of paraffins, n-paraffins, i-paraffins, mono-branched i-paraffins, multiple-branched i-paraffins, hydrocarbons, or fatty acids, respectively, where X_{Y} and X_{Z} are feasible end-value integers, wherein the carbon numbers within such range is as indicated by the end-value integers and any integers between said end-values, if present. However, paraffins, n-paraffins, i-paraffins, mono-branched i-paraffins, multiple-branched i-paraffins, hydrocarbons, or fatty acids, as the case may be, of all said carbon numbers within said range, particularly at or around the end points are not necessarily present, except when so expressly indicated. On the other hand, isomers, by definition, may comprise several compounds having the same carbon number, such as C15 isomers may comprise methyltetradecanes (different position of the methyl-branch), dimethyltridecanes (different positions of the two methyl-branches), etc, wherein “C15 isomers” comprises the sum amount of all such variants.

Typically, a sum amount as of weight or volume of paraffins, n-paraffins, i-paraffins, mono-branched i-paraffins, multiple-branched i-paraffins, hydrocarbons, or fatty acids, as defined each time, of all carbon numbers included is meant. For example, C15 to C22 n-paraffins refers to any n-paraffins within said range, such as C15, C16, C17, C18, C19, C20, C21, and C22 n-paraffins, even if the content of C15 n-paraffins was zero. In other words, a sum amount is obtainable by addition of 0 (referring to absent C15 n-paraffins) to the sum weight of all other C15 to C22 n-paraffins present.

The sum amount by weight of C6-C18 n-paraffins, C6-C18 monobranched i-paraffins, and C6-C18 multiple-branched i-paraffins as used herein defines the total weight of n-paraffins, and isoparaffins (monobranched i-paraffins and multiple-branched i-paraffins) having a carbon number C6, C7, C8, C9, C10, C11, C12, C13, C14, C15, C16, C17, or C18, wherein the weight for any individual compound may be 0 (considering the detection limit). Further, isoparaffins, even within single carbon number, contain several individual compounds dependent on the position, number, and stereochemistry of the branch (mono-branched i-paraffins) or branches (multiple-branched i-paraffins) therein, and yet, a sum weight thereof is added to the present sum amount. In other words, if the carbon number is C6-C18 and the compound is either n-paraffin or isoparaffin, it is counted in, and if the weight of said compound is 0, then 0 is added to said sum amount. It is hence understood that every compound falling within the definition is not necessarily present. Due to the selections made regarding the production process, for example C18 n-paraffins may be absent from the aviation fuel component. Nevertheless, a sum amount is obtainable by addition of 0 (referring to absent C18 n-paraffin) to the sum weight of all other C6-C18 n-paraffins and isoparaffins present.

Isomerisation converts at least a certain amount of n-paraffins to i-paraffins, especially to mono-branched i-paraffins. By (further) raising the isomerization degree, for example by increasing severity of the hydroisomerisation as described hereinafter, more n-paraffins can be converted to i-paraffins, and mono-branched i-paraffins can be converted to multiple-branched i-paraffins, such as di-branched, tri-branched i-paraffins, even i-paraffins comprising more than three branches.

As used herein and in the context of the second reactor section, degree of effective cracking refers to cracking that yields non-gaseous (NTP) cracking products, especially as expressed as the ratio of the C8 to C14 hydrocarbon content in the hydrocracking effluent to the C8 to C14 hydrocarbon content in the second reactor section feed.

As used herein, the term renewable refers to compounds or compositions that are obtainable, derivable, or originating from plants and/or animals, including compounds or compositions obtainable, derivable, or originating from fungi and/or algae, in full or in part. As used herein, renewable compounds or compositions may comprise gene manipulated compounds or compositions. Renewable feeds, components, compounds, or compositions may also be referred to as biological feeds, components, compounds, or compositions, or as biogenic feeds, components, compounds, or compositions.

As used herein, the term fossil refers to compounds or compositions that are obtainable, derivable, or originating from naturally occurring non-renewable compositions, such as crude oil, petroleum oil/gas, shale oil/gas, natural gas, or coal deposits, and the like, and combinations thereof, including any hydrocarbon-rich deposits that can be utilized from ground/underground sources. The term circular refers to recycled material typically originating from non-renewable sources. For example, the term circular may refer to recycled material originating from waste plastics.

Said renewable, circular, and fossil compounds or compositions are considered differing from one another based on their origin and impact on environmental issues. Therefore, they may be treated differently under legislation and regulatory framework. Typically, renewable, circular, and fossil compounds or compositions are differentiated based on their origin and information thereof provided by the producer.

Chemically the renewable or fossil origin of any organic compounds, including hydrocarbons, can be determined by suitable method for analyzing the content of carbon from renewable sources e.g. DIN 51637 (2014), ASTM D6866 (2020), or EN 16640 (2017). Said methods are based on the fact that carbon atoms of renewable or biological origin comprise a higher number of unstable radiocarbon (¹⁴C) atoms compared to carbon atoms of fossil origin. Therefore, it is possible to distinguish between carbon compounds derived from renewable or biological sources or raw material and carbon compounds derived from non-renewable or fossil sources or raw material by analyzing the ratio of ¹²C and ¹⁴C isotopes. Thus, a particular ratio of said isotopes can be used as a “tag” to identify a renewable carbon compound and differentiate it from non-renewable carbon compounds. The isotope ratio does not change in the course of chemical reactions. Therefore, the isotope ratio can be used for identifying renewable compounds, components, and compositions and distinguishing them from non-renewable, fossil materials in reactor feeds, reactor effluents, separated product fractions and various blends thereof. Numerically, the biogenic carbon content can be expressed as the amount of biogenic carbon in the material as a weight percent of the total carbon (TC) in the material (in accordance with ASTM D6866 (2020) or EN 16640 (2017)). In the present context, the term renewable preferably refers to a material having a biogenic carbon content of more than 50 wt-%, especially more than 60 wt-% or more than 70 wt-%, preferably more than 80 wt-%, more preferably more than 90 wt-% or more than 95 wt-%, even more preferably about 100 wt-%, based on the total weight of carbon in the material (EN 16640 (2017)).

According to a first aspect, herein is provided an aviation fuel component, comprising n-paraffins, mono-branched i-paraffins, and multiple-branched i-paraffins, wherein the sum amount of C6-C18 n-paraffins, C6-C18 mono-branched i-paraffins and C6-C18 multiple-branched i-paraffins is at least 90 wt-% of the total aviation fuel component weight, and wherein the weight ratio of C6-C18 multiple-branched i-paraffins to C6-C18 n-paraffins is at least 10, and wherein the aviation fuel component has T10 and T90 temperatures, as determined according to EN ISO 3405-2019, within a range from 120° C. to 295° C. The high content of paraffins, high isomerization degree as reflected by the very high weight ratio of multiple-branched i-paraffins to n-paraffins, and the specified T10 to T90 temperature range provide several advantages, as detailed later.

The present aviation fuel component comprises mainly n-paraffins, mono-branched i-paraffins, and multiple-branched i-paraffins. The sum amount of C6-C18 n-paraffins, C6-C18 mono-branched i-paraffins, and C6-C18 multiple-branched i-paraffins is at least 90 wt-%, preferably at least 93 wt-%, more preferably at least 95 wt-%, even more preferably at least 96 wt-%, such as from 90 wt-% to 99 wt-% or from 93 to 99 wt-%, of the total aviation fuel component weight. The remaining part, at most 10 wt-% of said aviation fuel component weight, may comprise non-paraffins (such as aromatics, naphthenes, and/or olefins), and/or paraffins having a carbon number of C5 or less, and/or paraffins having a carbon number of C19 or more. Said paraffins having carbon number of C5 or less or of C19 or more may be n-paraffins, mono-branched i-paraffins, and/or multiple-branched i-paraffins.

The present inventors have found the present aviation fuel component comprising high content of paraffins within carbon number range C6-C18 highly beneficial for several reasons. For example, high paraffin content leaves little room for aromatics, olefins and naphthenes, and reducing or minimizing their contents may support meeting safety, environmental and/or occupational health requirements and/or recommendations, as well as standards, such as ASTM D7566-21. High paraffin content may also provide ready biodegradability. Further, the present highly paraffinic aviation fuel component may provide better performance regarding burning and/or emissions to the end user. Further, the blendability of the present highly isoparaffinic aviation fuel component to other typical aviation fuel range components is very good. Further, the present highly paraffinic aviation fuel component is more stable or more inert e.g. during storage and in blends, compared to components with higher content of non-paraffins, particularly of olefins, that might react and form high molecular weight precipitates, i.e. gums, in the component or in blend composition thereof. Also, aromatics can be susceptible to instability, particularly with increasing aromatic size and concentration, resulting in a higher deposition propensity upon stressing e.g. caused by oxidation and molecular growth of the aromatics. Improved stability is a particularly desired property for aviation fuel components due to the strict maximum limit for existent gum in the aviation fuels. Additionally, a range of paraffins, such as a range within C6-C18, is more beneficial for end product properties when blended to other typical aviation fuel range components than a neat or pure component, such as neat C14 paraffin. Typically, the carbon number distribution of the paraffins in the present aviation fuel component covers at least six adjacent carbon numbers, preferably at least seven adjacent carbon numbers, more preferably at least eight or at least nine adjacent carbon numbers, within the C6-C18 range.

The present aviation fuel component has a high degree of isomerisation. This is reflected by a high content of isoparaffins, particularly multiple-branched isoparaffins, and low content of n-paraffins. Hence, according to certain preferred embodiments, in the present aviation fuel component the sum amount of C6-C18 monobranched i-paraffins and C6-C18 multiple-branched i-paraffins is at least 85 wt-%, preferably at least 87 wt-%, more preferably at least 90 wt-%, even more preferably at least 92 wt-% of the total aviation fuel component weight. In certain particularly preferred embodiments, the amount of C6-C18 multiple-branched i-paraffins is at least 58 wt-%, preferably at least 60 wt-%, more preferably at least 62 wt-% of the total aviation fuel component weight. Such i-paraffin and particularly multiple-branched isoparaffin contents are surprisingly high and especially interesting as they may not be limited to just a few carbon numbers, so that rather wide range of carbon numbers may be included in the present aviation fuel component while enhancing cold properties.

In the present aviation fuel component, the weight ratio of C6-C18 multiple-branched i-paraffins to C6-C18 n-paraffins is at least 10, preferably at least 10.0. In certain preferred embodiments, the weight ratio of C6-C18 multiple-branched i-paraffins to C6-C18 n-paraffins is at least 11, preferably at least 12, more preferably at least 14, even more preferably at least 16. Typically, said ratio is at most 30 or at most 25, such as within a range from 10 to 30, or from 10 to 25. Such high weight ratios are preferred as multiple-branched i-paraffins are believed to be more effective than mono-branched i-paraffins in compensating poor cold properties of n-paraffins. Hence, it is preferred that the present aviation fuel component has higher content of C6-C18 multiple-branched i-paraffins than of

C6-C18 mono-branched i-paraffins. In certain preferred embodiments, the weight ratio of C6-C18 multiple-branched i-paraffins to C6-C18 mono-branched i-paraffins is at least 1.6, preferably at least 1.7, more preferably at least 1.8, even more preferably at least 1.9 or at least 2.0. Typically, said weight ratio is at most 10, or at most 5.0, such as within a range from 1.6 to 5.0. The Examples herein show such exceptionally high weight ratios of C6-C18 multiple-branched i-paraffins to C6-C18 n-paraffins and of C6-C18 multiple to C6-C18 mono-branched i-paraffins.

In the present aviation fuel component, the isomerization degree is particularly high among the longer, C14-C18 paraffins. In certain preferred embodiments, the weight ratio of C14-C18 multiple-branched i-paraffins to C14-C18 n-paraffins is more than 20, preferably at least 30, more preferably at least 40, even more preferably at least 50, or at least 60. The Examples show that said ratio may be very high in the present aviation fuel components, often >70 or even >100. Very high ratios may be reached when the amount of n-paraffins approaches zero, although in practice some n-paraffins are typically present. Low n-paraffin content contributes to the improved cold properties, such as freezing point and/or kinematic viscosities at subzero temperatures. Even though a process for producing the present aviation fuel component, discussed in detail later, could be run to convert most of C14-C18 n-paraffins to isoparaffins, process economy may set an upper limit in practice, so that the weight ratio of C14-C18 multiple-branched i-paraffins to C14-C18 n-paraffins may be for example at most about 500, or at most 300, such as within a range from at least 20 to about 500. Another indicator of a very high isomerization degree is the weight ratio of C14-C18 multiple-branched i-paraffins to C14-C18 mono-branched i-paraffins. In the present aviation fuel component said weight ratio of C14-C18 multiple-branched i-paraffins to C14-C18 mono-branched i-paraffins may be more than 2.0, preferably at least 2.4, more preferably at least 2.6, even more preferably at least 2.8, or at least 3.0. Typically, said weight-ratio is at most 40, or at most 30, such as within a range from 2.0 to 40. While weight ratio(s) might better illustrate the high isomerization degree, isomerization degree may also be illustrated through the content of C14-C18 multiple-branched i-paraffins. In the present aviation fuel component, the content of C14-C18 multiple-branched i-paraffins may be at least 35 wt-%, preferably at least 40 wt-%, more preferably at least 45 wt-%, even more preferably at least 50 wt-% of the total aviation fuel component weight. In certain particularly preferred embodiments of the present aviation fuel component, the weight-ratio of C14-C18 multiple-branched i-paraffins with at least three branches to C14-C18 total i-paraffins may be at least 0.10, preferably at least 0.12, more preferably at least 0.15, even more preferably at least 0.17; and/or the content of C14-C18 multiple-branched i-paraffins with at least three branches may be at least 5 wt-%, preferably at least 8 wt-%, more preferably at least 10 wt-%, even more preferably at least 12 wt-%, typically at most 55 wt-%, or at most 50 wt-%, or at most 45 wt-%, of the total aviation fuel component weight. One reason for assessing the longer, C14-C18 paraffins separately, is that even low amounts of long n-paraffins can be detrimental to the cold properties of aviation fuel component. For example, C14-C18 n-paraffins have high melting points, typically well above 0° C., while C6-C13 n-paraffins have melting points below 0° C. Additionally, the level of multi-branching in the C14-C18 range, especially in terms of weight-ratio of C14-C18 multiple-branched i-paraffins with at least three branches to C14-C18 total i-paraffins, and/or content of multiple-branched i-paraffins with at least three branches, is believed to have a particularly beneficial impact on the cold properties, especially freezing point. When the weight-ratio to total i-paraffins or content of multiple-branched i-paraffins with at least three branches in the C14-C18 range is sufficiently high, C14-C18 range hydrocarbons may be incorporated in higher quantities without jeopardizing freezing point, or the freezing point may even be enhanced. Thus, achieving high isomerization degree among C14-C18 paraffins may be regarded very advantageous. Preferably, the present aviation fuel component comprises C19+ hydrocarbons at most 1.0 wt-%, further preferably at most 0.8 wt-%, more preferably at most 0.5 wt-%, even more preferably at most 0.3 wt-% of the total aviation fuel component weight.

High isomerization degree may be desired also in the C6-C13 paraffin range to further improve cold properties, but the shorter chain lengths make it more challenging to achieve good isomerization degree here. Surprisingly, it was found that the process disclosed herein is able to produce aviation fuel components having high overall isomerization degree, sufficiently high also in the C6-C13 range. The present aviation fuel component may have surprisingly high total isoparaffin contents also in the C6-C13 range, as shown by the Examples. Typically, the present aviation fuel component may comprise C6-C13 i-paraffins at least 20 wt-% or even at least 30 wt-% of the total aviation fuel component weight. Also, C6-C13 multiple-branched i-paraffins may be present in surprisingly high amounts. Hence, according to certain preferred embodiments, in the present aviation fuel component the amount of C6-C13 multiple-branched i-paraffins is at least 5.0 wt-%, preferably at least 7.0 wt-%, more preferably at least 8.0 wt-%, even more preferably at least 9.0 wt-% of the total aviation fuel component weight. Typically, the amount of C6-C13 multiple-branched i-paraffins is at most 30 wt-%, or at most 25 wt-%, such as within a range from 5 to 30 wt-% of the total aviation fuel component weight. According to certain typical embodiments, in the present aviation fuel component the weight ratio of C6-C13 total i-paraffins to C6-C13 n-paraffins is at least 5.0, preferably at least 6.0, more preferably at least 7.0, and/or the weigh ratio of C6-C13 multiple-branched i-paraffins to C6-C13 n-paraffins is at least 2.0, preferably at least 2.5, more preferably at least 3.0. Such ratios illustrate good isomerization degree also among the C6-C13 range paraffins.

Generally, a higher share of paraffins with shorter chain lengths can be expected to provide better cold properties compared to longer paraffins. Surprisingly, the present inventors found that excellent cold properties can be achieved even in aviation fuel components wherein the weight ratio of C14-C18 total paraffins to C6-C13 total paraffins is within a range from 0.8 to 5.0, preferably from 1.0 to 4.5, more preferably from 1.1 to 4.0, even more preferably from 1.2 to 3.5. Without being bound to any theory, it is believed that the remarkably high isomerization degree, particularly among C14-C18 paraffins, effectively compensates for somewhat lower isomerization degree in the C6-C13 range. At the same time, higher density may be achieved to the aviation fuel component. This is beneficial, as then incorporation of the present aviation fuel component into aviation fuel compositions even in high proportion does not decrease the density of the final blend below the minimum required e.g. in ASTM D7566-21 Table 1.

Generally, isoparaffins have lower boiling points than n-paraffins having the same carbon number. Hence, in certain preferred embodiments of the present aviation fuel component the weight ratio of C14-C18 total paraffins to C6-C13 total paraffins is from 0.8 to 5.0, preferably from 1.0 to 4.5, more preferably from 1.1 to 4.0, even more preferably from 1.2 to 3.5, and the ratio of the difference between T50 and T5 temperatures to the difference between T95 and T50 temperatures (T50−T5)/(T95−T50) is within a range from 0.7 to 6.0, preferably from 0.8 to 5.5, more preferably from 0.8 to 5.0, even more preferably from 0.9 to 4.0, or from 0.9 to 3.0, particularly from 0.9 to 2.5.

In the following some distillation characteristics of certain typical embodiments of the present aviation fuel component are disclosed.

In certain preferred embodiments, the aviation fuel component has a difference between T90 and T10 temperatures, as determined according to EN ISO 3405-2019, of at least 70° C., preferably at least 75° C., more preferably at least 80° C., even more preferably at least 85° C., typically at most 180° C., such as within a range from 80 to 150° C., preferably from 80 to 130° C. In such embodiments, the aviation fuel component may be recovered with improved yields, while reaching desired cold properties, density, and flash point characteristics.

In certain typical embodiments, the aviation fuel component has a T10 temperature of at least 120° C., preferably at least 130° C., typically at most 220° C., preferably at most 210° C., such as within a range from 120° C. to 220° C., or from 130° C. to 210° C., as determined according to EN ISO 3405-2019.

In certain typical embodiments, the aviation fuel component has a T90 temperature of at least 250° C., preferably at least 255° C., typically at most 295° C. or at most 290° C., such as within a range from 250° C. to 295° C., or from 255° C. to 290° C., as determined according to EN ISO 3405-2019. In certain typical embodiments, the aviation fuel component has a final boiling point (FBP) at most 300° C., and typically at least 270° C., such as within a range from 270° C. to 300° C., as determined according to EN ISO 3405-2019. These embodiments are desired for complying with requirements of ASTM D7566-21 Annex A2 for isoparaffinic kerosene obtained from hydroprocessed fatty feedstocks.

In certain preferred embodiments, the aviation fuel component has an initial boiling point (IBP) of at least 90° C., preferably at least 100° C., more preferably at least 110° C., even more preferably at least 120° C., and typically at most 190° C., or at most 180° C., such as within a range from 90° C. to 190° C., or from 100° C. to 180° C. In these embodiments a desired flash point may be reached without unnecessary decrease in the yield.

In certain preferred embodiments, in the aviation fuel component the ratio of the difference between T50 and T5 temperatures to the difference between T95 and T50 temperatures (T50−T5)/(T95−T50) is within a range from 0.7 to 6.0, preferably from 0.8 to 5.5, more preferably from 0.8 to 5.0, even more preferably from 0.9 to 4.0, or from 0.9 to 3.0, particularly from 0.9 to 2.5. These embodiments have a more balanced boiling point distribution, and may thus provide enhanced burning properties.

The present aviation fuel component showed surprisingly good viscosities at subzero temperatures when determined experimentally. Hence, according to certain embodiments, the aviation fuel component has a kinematic viscosity at −20° C. as determined according to EN ISO 3104-2020 within a range from 4.0 to 10.0 mm²/s, preferably from 4.0 to 9.5 mm²/s, more preferably from 4.0 to 8.5 mm²/s. In certain further embodiments, the aviation fuel component has a kinematic viscosity at −40° C. as determined according to EN ISO 3104-2020, within a range from 9.0 to 30.0 mm²/s, preferably from 10.0 to 28.0 mm²/s, more preferably from 10.0 to 25.0 mm²/s.

In certain typical embodiments, the aviation fuel component has a flash point as determined according to IP 170-2013 (Abel closed-cup method) of at least 38° C.

In certain typical embodiments, the aviation fuel component has a freezing point as determined according to IP 529-2016 of −40° C. or less, preferably −50° C. or less, more preferably −60° C. or less, even more preferably of −70° C. or less. Surprisingly, the freezing point for some of the samples of aviation fuel component according to the present disclosure shown in the Examples was clearly below −70° C. Such results are extremely beneficial for fuel components for use in aviation fuels.

In certain typical embodiments, the aviation fuel component has a density at 15° C. as determined according to EN ISO 12185-1996 within a range from 750 to 780 kg/m³, preferably from 750 to 775 kg/m³, more preferably from 750 to 772 kg/m³.

In certain preferred embodiments, the aviation fuel component has a biogenic carbon content (EN 16640 (2017)) of at least 50 wt-%, preferably at least 70 wt-%, more preferably at least 90 wt-% based on the total weight of carbon (TC) in the aviation fuel component.

Compared to prior art paraffinic aviation fuels or fuel components, the present aviation fuel component provides surprisingly good cold properties, such as freezing point, kinematic viscosity at −20° C. and/or kinematic viscosity at −40° C. In the present aviation fuel component, the isomerization degree may be high throughout the carbon number range, and especially in the C14-C18 range, so that the carbon numbers need not to be limited from the upper end by distillation, but rather high carbon numbers may be included in the present aviation fuel component. In some prior art processes, the final boiling point in the recovery of an aviation fuel component needs to be limited much below 300° C. so as to reduce the amount of higher n-paraffins, such as C17 or even C16 n-paraffins, that could destroy the cold properties. For the present aviation fuel components this is not required, due to the very high isomerization degree as represented for example by the specified weight ratio of C6-C18 multiple-branched i-paraffins to C6-C18 n-paraffins. Therefor the present aviation fuel components can be recovered with better yields, while still reaching a desired combination of low freezing point, low kinematic viscosity at −20° C., sufficient flash point, and sufficient density that does not limit the blending ratio by decreasing the density of a final blend below a required minimum.

The beneficial characteristics, especially the very high overall isomerization degree of the present aviation fuel component and the excellent cold properties may be contributed by the production process and a feed thereto. Additives or enhancers may not be necessary. The aviation fuel component may be directly obtainable or obtained from product recovery of the production process.

In certain embodiments, the aviation fuel component is obtainable or obtained by a process comprising providing a paraffinic hydrocarbon feed, preferably obtained by hydrodeoxygenation of an oxygenated hydrocarbon feed typically comprising vegetable oils, animal fats, and/or microbial oils and optionally followed by gas-liquid separation and/or paraffinic feed fractionation(s), and subjecting the paraffinic hydrocarbon feed to at least hydroisomerisation, preferably to hydroisomerisation and hydrocracking, followed by fractionation, and recovering from the fractionation at least the aviation fuel component. The feed(s) and process steps, especially the paraffinic hydrocarbon feed, the hydroisomerisation and the optional hydrocracking, and the fractionation, are preferably as further defined herein.

According to certain preferred embodiments, the present aviation fuel component is obtainable by a process comprising
providing a paraffinic hydrocarbon feed comprising at least 60 wt-% paraffins of the total weight of the paraffinic hydrocarbon feed, of which paraffins at most 30 wt-% are i-paraffins;
subjecting the paraffinic hydrocarbon feed in a first reaction section, preferably in a first reactor, to hydroisomerisation in the presence of a hydroisomerisation catalyst to obtain a hydroisomerisation effluent;
subjecting a second reaction section feed comprising at least a portion of the hydroisomerisation effluent to hydrocracking in a second reaction section, preferably in a second reactor, in the presence of a hydrocracking catalyst to obtain a hydrocracking effluent;
subjecting the hydrocracking effluent, and optionally (at least) a portion of the hydroisomerisation effluent, to fractionation, and recovering from the fractionation at least the aviation fuel component, and optionally a gasoline fuel component and/or a diesel fuel component.

Optionally, also other products, such as a marine fuel component, may be recovered.

Preferably the process further comprises recovering from the fractionation a recycle stream, preferably having a T5 temperature (5 vol-% recovered, EN ISO 3405-2019) of 270° C. or higher and optionally comprising C16 n-paraffins. The recycle stream may be comprised in the at least a portion of the hydroisomerisation effluent or form the at least a portion of the hydroisomerisation effluent subjected to hydrocracking in the second reaction section, preferably second reactor. In other words, the recycle stream is subjected, as part of the second reaction section feed, to hydrocracking in the second reaction section, preferably in the second reactor. The recycle stream may comprise at least a portion of the fractionation bottom. In embodiments where a recycle stream is separated, the yield of desired liquid fuel component(s) can be further optimised, particularly in embodiments where the second reaction section feed fed to hydrocracking comprises in addition to the recycle stream a further portion of the hydroisomerisation effluent. In embodiments where a recycle stream is separated, a diesel fuel component is conveniently recovered by separating a portion from the recycle stream.

In the present process, the paraffinic hydrocarbon feed comprises at least 60 wt-%, preferably at least 70 wt-%, more preferably at least 80 wt-%, even more preferably at least 90 wt-% paraffins of the total weight of the paraffinic hydrocarbon feed. The paraffinic hydrocarbon feed of the present disclosure may comprise even at least 95 wt-% paraffins of the total weight of the paraffinic hydrocarbon feed or consist essentially of paraffins. The paraffinic hydrocarbon feed of the present disclosure may contain minor amounts of olefins, preferably less than 5 wt-%, more preferably less than 1 wt-%, based on the total weight of the paraffinic hydrocarbon feed, as well as minor amounts of aromatics and/or naphthenes.

An advantage of using a highly paraffinic hydrocarbon feed in the process of the present disclosure is that paraffins are isomerised relatively easily and at milder conditions when subjected to hydroisomerisation compared to e.g. cyclic hydrocarbons. Also, paraffins crack relatively easily and at milder conditions when subjected to hydrocracking, which helps to reduce formation of light gases.

In the present process, the paraffinic hydrocarbon feed comprising at least 60 wt-% paraffins of the total weight of the paraffinic hydrocarbon feed, of which paraffins at most 30 wt-% are i-paraffins, may be obtained from a paraffinic hydrotreatment effluent, such as a hydrodeoxygenation (HDO) effluent, a paraffinic Fischer-Tropsch (FT) effluent, or a combination thereof, after having subjected said effluent(s) at least to gas-liquid separation, i.e. removal of at least compounds that are gaseous at NTP, and optionally also to paraffinic feed fractionation(s). While e.g. paraffinic FT effluents of fossil origin are readily available (in addition to FT effluents of renewable origin), preferably the paraffinic hydrocarbon feed of the present disclosure is at least partially renewable, i.e. comprises biogenic components.

Preferably, the paraffinic hydrocarbon feed of the present disclosure comprises or consists essentially of a hydrodeoxygenation (HDO) effluent, or a fraction thereof, such as a degassed hydrodeoxygenation effluent or a fraction thereof, from catalytic hydrodeoxygenation (catalytic HDO) of an oxygenated hydrocarbon feed. Preferably the oxygenated hydrocarbon feed comprises at least one or more of vegetable oil, animal fat and/or microbial oil. This kind of paraffinic hydrocarbon feeds tend to have relatively narrow carbon number distribution and therefor benefit more from being subjected to the present process, compared e.g. to FT-based feeds usually having substantially Gaussian distribution of hydrocarbon chains and a wide carbon chain length distribution. Typically providing the paraffinic hydrocarbon feed comprises subjecting an oxygenated hydrocarbon feed to hydrodeoxygenation in the presence of a hydrodeoxygenation catalyst to obtain a hydrodeoxygenation effluent, and then subjecting the hydrodeoxygenation effluent to gas-liquid separation, and optional paraffinic feed fractionation to obtain as the paraffinic hydrocarbon feed the degassed hydrodeoxygenation effluent or a fraction thereof. Hydrodeoxygenation may be conducted as described in prior art publications, such as FI100248B, EP1741768A1, EP2155838B1 or FI129220 B1. Typically, the hydrodeoxygenation is conducted without presence of added water, i.e. without adding water separate from the paraffinic hydrocarbon feed,

Generally, in the context of the present disclosure, hydroisomerisation (HI) of the paraffinic hydrocarbon feed in the first reaction section/reactor is operated so that isomerisation reactions prevail while cracking reactions are controlled or suppressed. Typically the HI in the first reaction section/reactor is conducted at a temperature within a range from 200° C. to 500° C., preferably from 230° C. to 500° C., more preferably from 250° C. to 450° C., even more preferably from 280° C. to 400° C., a pressure within a range from 1 MPa to 10 MPa, preferably from 2 MPa to 8 MPa or from 3 MPa to 10 MPa, a H₂ partial pressure at the inlet of the first reaction section/reactor within a range from 1 MPa to 10 MPa, preferably from 2 MPa to 8 MPa, a weight hourly space velocity within a range from 0.1 to 10, preferably from 0.2 to 8, more preferably from 0.4 to 6 kg paraffinic hydrocarbon feed per kg catalyst per hour, and a H₂ to paraffinic hydrocarbon feed ratio within a range from 10 to 2000, preferably from 50 to 1000 normal liters H₂ per liter paraffinic hydrocarbon feed. Hydroisomerisation may be conducted as described in prior art publications, such as FI100248B, EP1741768A1, EP2155838B1 or FI129220 B1. Severity of the HI may be increased by at least one or more of: decreasing WHSV, increasing temperature, and/or increasing pressure. When using fresh HI catalyst, high severity HI conditions may be reached at lower temperature and/or pressure, and/or using higher WHSV, and towards the end of the HI catalyst lifetime higher temperature and/or pressure, and/or lower WHSV may be needed to reach even medium severity HI. In the present context, HI that yields liquid effluents having, as wt-% of paraffins in the liquid effluent, total i-paraffins content 50-85 wt-% and multiple-branched i-paraffins content at most 25 wt-%, or total i-paraffins content 85-95 wt-% and multiple-branched i-paraffins content 25-55 wt-%, or total i-paraffins content at least 95 wt-% and multiple-branched i-paraffins content more than 55 wt-%, is generally regarded as HI of low severity, or medium severity, or high severity, respectively, although these content ranges are merely for illustrating the order of magnitude, and may overlap to some extent, and vary from case to case.

Generally hydrocracking in the second reaction section/reactor is operated so that cracking reactions, especially those enhancing degree of effective cracking, particularly to C8-C14 hydrocarbons but also to lighter non-gaseous hydrocarbons, are more abundant than in the hydroisomerisation in the first reaction section/reactor. Preferably cracking reactions, especially those enhancing the degree of effective cracking, prevail in the hydrocracking in the second reaction section/reactor, yet generally without excessive cracking and excessive fuel gas formation. Typically the hydrocracking in the second reaction section/reactor is conducted at a temperature within a range from 200° C. to 450° C., preferably from 220° C. to 430° C., more preferably from 280° C. to 350° C., a pressure within a range from 0.4 MPa to 8 MPa, preferably from 1 MPa to 7 MPa, a H₂ partial pressure at the inlet of the second reaction section/reactor within a range from 0.4 MPa to 8 MPa, preferably from 1 MPa to 7 MPa, a weight hourly space velocity within a range from 0.1 to 10, preferably from 0.2 to 8, more preferably from 0.4 to 6, even more preferably from 0.5 to 1.5 kg second reactor feed per kg catalyst per hour, and a H₂ to second reactor feed ratio within a range from 10 to 2000, preferably from 50 to 1000 normal liters H₂ per liter second reactor feed.

Preferably, the hydroisomerisation catalyst is a non-sulphided bifunctional hydroisomerisation catalyst and the hydrocracking catalyst is a non-sulphided bifunctional hydrocracking catalyst, preferably said non-sulphided bifunctional catalysts comprising at least one or more metal(s) selected from noble metals of Group VIII, more preferably at least one or more metal(s) selected from Pt and/or Pd, and at least one or more acidic porous material(s). Non-sulphided bifunctional catalysts are preferred because they do not require sulphidation during operation for maintaining their activity, and hence the sulphur content of various process streams and products may be kept low and less efficient H₂S separation and recovery is needed. Especially non-sulphided bifunctional catalysts comprising noble-metals may be active at lower temperatures and show higher selectivity for isomerisation reactions, compared to sulphided catalysts, but are sensitive to deactivation by H₂S. Particularly for the hydrocracking reactions in the second reaction section/reactor, bifunctional HC catalysts are beneficial because they have in addition to cracking activity also at least some isomerisation activity, and may be especially efficient in effective cracking. As further advantage, bifunctional hydrocracking catalysts comprising at least one or more metals selected from Group Vill noble metals, preferably Pt and/or Pd, have been found to provide at relatively low temperatures a high activity compared to HC catalysts comprising non-noble metals, and thus better control of thermal cracking. At low temperatures, the thermodynamic equilibrium tends to shift towards dearomatisation, thus reducing aromatics formation by side reactions. Providing the second reaction section/reactor with a bifunctional HC catalyst may also achieve an isoparaffin content (wt-% isoparaffins of the total weight paraffins) in the hydrocracking effluent that is not necessarily significantly lower than in the hydroisomerisation effluent, or may be the same or even higher.

According to certain preferred embodiments, the present aviation fuel component is obtainable by a process comprising
subjecting an oxygenated hydrocarbon feed comprising at least one or more of vegetable oil, animal fat and/or microbial oil to hydrodeoxygenation, followed by gas-liquid separation, to provide a paraffinic hydrocarbon feed comprising at least 60 wt-% paraffins of the total weight of the paraffinic hydrocarbon feed, of which paraffins at most 30 wt-% are i-paraffins;
subjecting the paraffinic hydrocarbon feed in a first reaction section, preferably in a first reactor, to hydroisomerisation in the presence of a hydroisomerisation catalyst to obtain a hydroisomerisation effluent;
subjecting a second reaction section feed comprising at least a portion of the hydroisomerisation effluent, optionally comprising a recycle stream, to hydrocracking in a second reaction section, preferably in a second reactor, in the presence of a hydrocracking catalyst to obtain a hydrocracking effluent;
subjecting the hydrocracking effluent to fractionation, and recovering from the fractionation at least the aviation fuel component, and optionally a gasoline fuel component and/or a diesel fuel component and/or the recycle stream preferably having a T5 temperature (5 vol-% recovered, EN ISO 3405-2019) of 270° C. or higher.

The prevailing component in the paraffinic hydrocarbon feed is n-paraffins. However, the presence of a certain amount of i-paraffins in the paraffinic hydrocarbon feed may still be beneficial. Compared to otherwise similar feeds but without i-paraffin content, paraffinic hydrocarbon feeds containing a certain amount of i-paraffins may achieve a hydroisomerisation effluent with a higher content of multiple-branched i-paraffins.

Preferably, the paraffinic hydrocarbon feed of the present disclosure comprises at least 70 wt-%, preferably at least 80 wt-%, more preferably at least 90 wt-% hydrocarbons having a carbon number within a range from C12 to C30, even more preferably within a range from C14 to C22, of the total weight of the paraffinic hydrocarbon feed. These feeds allow good yields of two or more fuel components of different kinds, and are readily available for example from conventional hydrodeoxygenation processes of vegetable oils, animal fats and/or microbial oils, comprising fatty acids. Paraffinic feeds on the heavier side are obtainable e.g. from HDO of oil from energy crops such as Brassica species, algal oils, crude tall oil (CTO), tall oil fatty acids (TOFA), and/or tall oil pitch (TOP).

Presence of multiple-branched i-paraffins in the hydroisomerisation effluent may be considered beneficial as it may contribute beneficially to the degree of effective cracking in the hydrocracking step. When a desired degree of effective cracking, particularly to C8-C14 hydrocarbons but also to lighter non-gaseous hydrocarbons, is achieved in the hydrocracking step at milder operating conditions, excessive cracking may be avoided, and formation of gaseous hydrocarbons reduced. Also, an increased content of multiple-branched i-paraffins in the hydroisomerisation effluent may be considered beneficial in that it may provide improved cold properties to the aviation fuel component as well as to the optionally recovered diesel fuel component, and/or improved RON to the optionally recovered gasoline fuel component. Without being bound to any theory, it is believed that a multiple-branched i-paraffin is more likely to form two branched paraffin molecules upon cracking in the hydrocracking step instead of one branched and one n-paraffin, hence increasing the i-paraffin content of the hydrocracking effluent relative to n-paraffin content. The same can be seen also downstream in the products recovered from fractionation, and in an optionally recovered recycle stream.

According to certain embodiments, the first reaction section for hydroisomerisation, and the second reaction section for hydrocracking may be situated in one and the same reactor, e.g in separate catalyst beds with appropriate equipment thereto. According to certain other embodiments, the first reaction section for hydroisomerisation is in a first reactor and the second reaction section for hydrocracking is in a second reactor. Having the hydroisomerisation section in a first reactor and the hydrocracking section in a second reactor provides advantages i.e. in process design, process controls, and maintenance.

Preferably, the at least a portion of the hydroisomerisation effluent subjected to hydrocracking comprises at least 50 wt-%, further preferably at least 60 wt-%, more preferably at least 70 wt-%, even more preferably at least 80 wt-% isoparaffins of the total amount of paraffins in the at least a portion of the hydroisomerisation effluent, and optionally multiple-branched isoparaffins at least 5 wt-%, preferably at least 10 wt-%, more preferably at least 15 wt-%, even more preferably at least 20 wt-%, and typically at most 70 wt-%, of the total amount of paraffins in the at least a portion of the hydroisomerisation effluent. Typically, the at least a portion of the hydroisomerisation effluent has a cloud point less than 0° C., preferably less than −5° C., more preferably less than −8° C., even more preferably less than −10° C., or less than −15° C. (ASTM D 5771-17).

Hydrocracking of at least a portion of the hydroisomerisation effluent increases the yield of non-gaseous cracking products, particularly C8-C14 but also lighter non-gaseous hydrocarbons, contributing to yield(s) of component(s) in gasoline and/or aviation fuel range. As the feed to the hydrocracking may contain elevated i-paraffins content, and elevated multiple-branched i-paraffins content, the present inventors have found that with the hydrocracking it is possible to yield further i-paraffins instead of decreasing their amount, without excessive cracking to less valuable light C1-C3 hydrocarbons.

The advantageous hydrocarbon composition of the present aviation fuel component, specifically in relation to the relatively broad carbon number distribution mainly in the C6-C18 range, very high content of i-paraffins, particularly of multiple-branched i-paraffins, and very low content of n-paraffins, is demonstrated to enhance also its physico-chemical characteristics, for example those desired for use in aviation fuel compositions. When studied in laboratory conditions, characteristics correlating with properties desired for fuels are e.g. the shape of the distillation curve and distillation characteristics.

According to a second example aspect, an aviation fuel composition is provided comprising an aviation fuel component, as defined herein, preferably in an amount from 1 vol-% to 99.5 vol-%, preferably from 5 vol-to 95 vol-%, more preferably from 10 vol-% to 70 vol-%, such as in an amount of at least 10 vol-%, at least 15 vol-%, at least 20 vol-%, at least 25 vol-%, at least 30 vol-%, at least 35, vol-%, at least 40 vol-%, at least 45 vol-%, at least 50 vol-%, at least 55 vol-%, at least 60 vol-%, or at least 65 vol-% of the total aviation fuel composition volume. The aviation fuel component may be incorporated in aviation fuel compositions in surprisingly high volume share in particular due to its exceptionally good cold properties compared to conventional paraffinic aviation fuel components. The present aviation fuel component may have a very high isomerisation degree and relatively broad carbon number distribution, and it is particularly useful in aviation fuel compositions, wherein it may be incorporated even in very high proportions.

The rest of the aviation fuel composition may consist of aviation fuel components, and optionally additives, especially those typical for the prior art. Most common aviation fuel components are currently fossil aviation fuel components. An exemplary aviation fuel composition of the present disclosure may comprise e.g. the present aviation fuel component, a conventional fossil aviation fuel component, and an antioxidant. In certain preferred embodiments, the aviation fuel composition fulfills the requirements for aviation fuels set in ASTM D7566-21 Table 1.

According to a third example aspect, an aviation fuel component, as defined herein, may be used in an aviation fuel composition for improving one or more product properties of the aviation fuel composition. Said one or more product properties of the aviation fuel composition may comprise at least one or more of kinematic viscosity at −20° C., kinematic viscosity at −40° C., freezing point, density, and/or biogenic carbon content.

In certain embodiments there is provided the use of the present aviation fuel component to provide an aviation fuel composition fulfilling the requirements for aviation fuels set in ASTM D7566-21 Table 1.

In certain embodiments, the aviation fuel component may be used in an aviation fuel composition in an amount from 1 vol-% to 99.5 vol-%, preferably from 5 vol-% to 95 vol-%, more preferably from 10 vol-% to 70 vol-%, such as in an amount of 10 vol-%, 15 vol-%, 20 vol-%, 25 vol-%, 30 vol-%, 35, vol-%, 40 vol-%, 45 vol-%, 50 vol-%, 55 vol-%, 60 vol-%, or 65 vol-% of the total aviation fuel composition volume. Such use may improve at least the cold properties, and preferably also the biogenic carbon content of the aviation fuel composition.

In addition to the usability in aviation fuel compositions, the present aviation fuel component is suitable for a wide range of various other uses, such as in solvent(s), in carrier(s), in dispersant composition(s), in demulsifier(s), in extractant(s), in detergent(s), in degreasing composition(s), in cleaner(s), in thinner(s), in penetrating oil(s), in anticorrosion composition(s), in multipurpose oil(s), in metal working fluid(s), in rolling oil(s) especially for aluminium, in cutting oil(s), in drilling fluid(s), in lubricant(s), in extender oil(s), in paint composition(s), in coating fluid(s) or paste(s), in adhesive(s), in resin(s), in varnish(es), in printing paste(s) or ink(s), in plasticizing oil(s), in turbine oil(s), in hydrophobization composition(s), in agriculture, in crop protection fluid(s), in construction, in concrete demoulding formulation(s), in electronic(s), in medical appliance(s), in feedstock(s) for industrial conversion process(es), preferably in thermal cracking feedstock(s) and/or in catalytic cracking feedstock(s), in composition(s) for car, electrical, textile, packaging, paper and/or pharmaceutical industry, and/or in manufacture of intermediate(s) therefor. The elevated content of isoparaffins, and also multiple-branched isoparaffins, as well as the specified T10 to T90 temperature range of the present aviation fuel composition may improve fluidity, pumping and mixing characteristics, and blendability, that are generally desired and beneficial properties for a wide range of uses, and particularly for uses involving spraying, injecting and/or admixing with other ingredients.

Depending on the intended use, the aviation fuel component or the aviation fuel composition may be suitably additized, for example with at least one or more of antioxidant(s), electrical conductivity additive(s), stabilizer(s), detergent(s), corrosion inhibitor(s), friction modifier(s), metal deactivator(s), lubricating additive(s), antifoaming agent(s), and/or fuel dye(s), just to name a few. Typically, the aviation fuel component may comprise antioxidant(s) from 17 mg to 24 mg of active ingredient per litre of the aviation fuel component (volume). The antioxidant(s) may be added to the bulk product prior to movements or operations that will significantly expose the product to air and in such a way as to ensure adequate mixing. This is preferably done as soon as practicable after hydroprocessing or fractionation to prevent peroxidation and gum formation after manufacture, using e.g. in-line injection and tank blenders.

### Schematic Presentation of the Process

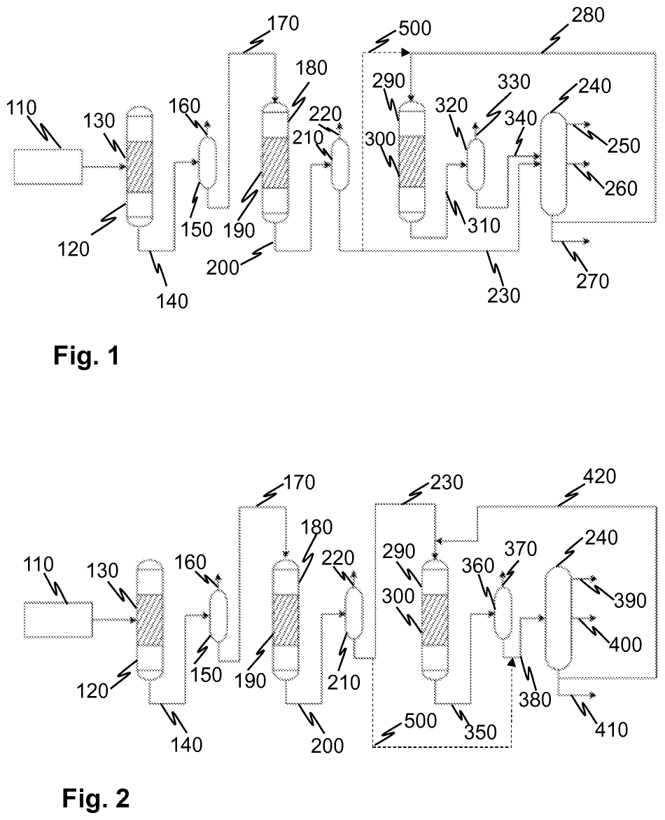

FIG. 1 schematically shows a process according to an example embodiment for producing the present aviation fuel component. In FIG. 1, oxygenated hydrocarbon feed 110 is fed to a HDO reactor 120 in which it is subjected to hydrodeoxygenation (HDO) in the presence of a HDO catalyst 130 to obtain a hydrodeoxygenation effluent (HDO effluent) 140, andthe obtained HDO effluent 140 is subjected to gas-liquid separation 150 to separate from the HDO effluent at least compounds that are gaseous at NTP 160 to obtain a degassed HDO effluent 170, which is in this example embodiment the herein defined paraffinic hydrocarbon feed. The degassed HDO effluent 170 is in FIG. 1 then fed to a first reactor 180 in which the degassed HDO effluent 170 is subjected to hydroisomerisation in the presence of a hydroisomerisation catalyst 190 to obtain a hydroisomerisation effluent (HI effluent) 200., and the obtained HI effluent 200 is subjected to gas-liquid separation 210 to separate from the HI effluent 200 at least compounds that are gaseous at NTP 220 to obtain a degassed HI effluent 230. In FIG. 1, the degassed HI effluent 230 is fed to a distillation unit 240, that may comprise a single column, or prefractionation and main distillation columns, from which several streams or cuts are obtained. From the distillation in FIG. 1, an aviation fuel component 260, and a diesel fuel component 270 and/or a gasoline fuel component 250 are recovered. and a recycle stream 280 having a T5 boiling point of 270° C. or higher is also separated, and the diesel fuel component 270 may be separated as a portion therefrom. A second reaction section feed comprising the recycle stream 280 as the at least a portion of the HI effluent is in FIG. 1 fed to a second reactor 290 in which it is subjected to hydrocracking in the presence of a hydrocracking catalyst 300 to obtain a hydrocracking effluent 310. In FIG. 1, the hydrocracking effluent 310 is subjected to gas-liquid separation 320 to separate from the hydrocracking effluent 310 at least compounds that are gaseous at NTP 330 to obtain a degassed hydrocracking effluent 340. The degassed hydrocracking effluent 340 is then fed as a co-feed with the degassed HI effluent 230 to the distillation unit 240 for fractionation. In certain embodiments yet another portion of the HI effluent 200, 230 may be fed as a co-feed 500 with the recycle stream 280, i.e. as part of the second reaction section feed, to hydrocracking in the second reactor 290.

FIG. 2 schematically shows a process according to another example embodiment for producing the present aviation fuel component. In FIG. 2, oxygenated hydrocarbon feed 110 is fed to a HDO reactor 120 in which it is subjected to hydrodeoxygenation in the presence of a HDO catalyst 130 to obtain a hydrodeoxygenation effluent (HDO effluent) 140, and the obtained HDO effluent 140 is subjected to gas-liquid separation 150 to separate from the HDO effluent at least compounds that are gaseous at NTP 160 to obtain a degassed HDO effluent 170, which is in this example embodiment the herein defined paraffinic hydrocarbon feed. The degassed HDO effluent 170 is in FIG. 2 then fed to a first reactor 180 in which the degassed HDO effluent 170 is subjected to hydroisomerisation in the presence of a hydroisomerisation catalyst 190 to obtain a hydroisomerisation effluent (HI effluent) 200, and the obtained HI effluent 200 is subjected to gas-liquid separation 210 to separate from the HI effluent 200 at least compounds that are gaseous at NTP 220 to obtain a degassed HI effluent 230. In FIG. 2, a second reaction section feed comprising the degassed HI effluent 230 is fed to a second reactor 290 in which it is subjected to hydrocracking in the presence of a hydrocracking catalyst 300 to obtain a hydrocracking effluent 350, and the hydrocracking effluent 350 is subjected to gas-liquid separation 360 to separate from the hydrocracking effluent 350 at least compounds that are gaseous at NTP 370 to obtain a degassed hydrocracking effluent 380. In FIG. 2, the degassed hydrocracking effluent 380 is fed to a distillation unit 240, that may comprise a single column, or prefractionation and main distillation columns, where it is fractionated into several streams or cuts. From the distillation in FIG. 2, an aviation fuel component 400, and a diesel fuel component 410 and/or a gasoline fuel component 390 are recovered. When a recycle stream 420, preferably having a T5 boiling point of 270° C. or higher, is separated, the diesel fuel component 410 may be separated as a portion therefrom. In FIG. 2, the recycle stream 420 may be fed to the second reactor 290 to hydrocracking as a co-feed with the degassed HI effluent 230, i.e. as part of the second reaction section feed. In certain embodiments a portion of the HI effluent 200, 230 may be fed as a co-feed 500 with the hydrocracking effluent 350, 380 to the fractionation.

### EXAMPLES

### Example 1—Production of Present Aviation Fuel Components

The aviation fuel components studied herein were recovered from test runs, where four different hydrocracking (HC) feeds (feed A, B, C, and D) were obtained by subjecting two different types of fatty feedstocks to hydrodeoxygenation (HDO) and gas-liquid separation to obtain paraffinic hydrocarbon feed comprising >95 wt-% paraffins based on the total weight of the paraffinic hydrocarbon feed, said paraffinic hydrocarbon feed further subjected to hydroisomerisation (HI) of different severity. A fraction of the hydroisomerisation effluent obtained by degassing the hydroisomerisation effluent, or by recovery of just a bottom fraction, was hydrocracked, followed by degassing or degassing and stabilising the effluent from hydrocracking. From the thus obtained (liquid) hydrocracking effluent at least an aviation fuel component, of particular interest here, was recovered as the main product, and gasoline and diesel fuel components could be obtained as additional products. The so obtained aviation fuel components were renewable due to the starting material (two different types of fatty feedstocks) of renewable origin. For one of the hydrocracking effluents (test run 8), a second fractionation was conducted in an optimised way so as to increase the aviation fuel component yield (test run 8 with optimised fractionation, TR8o). Details of the hydrocracking feeds are given in Table 1, and Table 2 shows process details for the hydrocracking as well as approximate boiling point ranges and yields of the renewable aviation fuel components. Physico-chemical properties and chemical composition of the aviation fuel components are reported in Examples 2 and 3.

TABLE 1
Details of the hydrocracking feeds.

| | HC Feed B | HC Feed A | | |
|---|---|---|---|---|
| | Animal fat/ | Animal fat/ | | |
| | vegetable oil | vegetable oil | | HC Feed D |
| | base subjected | base subjected | HC Feed C | Animal fat/ |
| | to HDO, high | to HDO, low | Heavy vegetable | vegetable oil |
| | severity HI, | severity HI, | oil/animal fat | base subjected |
| | degassing, and | degassing, and | base subjected | to HDO, medium |
| | recovery of | recovery of | to HDO, medium | severity HI, |
| | bottom fraction | bottom fraction | severity HI, and | degassing, and |
| | as HC feed | as HC feed | degassing | stabilising |
| Cloud point, ° C. | −30 | −11 | −27 | −34 |
| (ASTM D 5771- | | | | |
| 17) | | | | |
| Density at | 788 | 786 | 779 | 780 |
| 15° C., kg/m³ | | | | |
| (EN ISO 12185- | | | | |
| 1996) | | | | |
| IBP to FBP, ° C. | 284 to 327 | 286 to 317 | 78 to 344 | 200 to 305 |
| (ENISO3405-19) | | | | |
| T5; T10 to T90, | 292; 293 to 300 | 294; 295 to 301 | 208; 251 to 323 | 247; 261 to 293 |
| ° C. (ENISO3405- | | | | |
| 2019) | | | | |
| Paraffins, wt-% | nP 3 wt-%; total | nP 13 wt-%; | nP 5 wt-%; total | nP 4 wt-%; total |
| (GCxGC-FID/ | iP 97wt-%; | total iP 87 wt-%; | iP 94 wt-%; | iP 95 wt-%; |
| GCxGC-MS) | multi-iP 64 wt-%; | multi-iP 23 wt-%; | multi-iP 59 wt-%; | multi-iP 53 wt- |
| | C15-C18 (each | C15-C18 (each | C15-C22 (each | %; C15-C18 |
| | present): 94 wt- | present): 96 wt- | present): 88 wt- | (each present): |
| | % in total | % in total | % in total | 89 wt-% in total |

TABLE 2
Process details for test run conditions in hydrocracking, cloud points of degassed
hydrocracking effluents, approximate boiling point ranges and yields of the
aviation fuel components (AC) (as wt-% of the degassed HC effluent).

| | | | Effluent's | | Approx. AC | AC |
|---|---|---|---|---|---|---|
| Test | HC | | cloud | Yield of | boiling point | sample |
| Run | Feed | HC conditions | point, ° C. | AC, wt-% | range | code |
| 8 | A | 348° C., 40 bar, WHSV | −78 | 56.9 | ~150° C. to | AC_TR8 |
| | | 0.8 1/h, H₂ 300 nL/L | | | ~300° C. | |
| 15 | B | 348° C., 40 bar, WHSV | −79 | 55.2 | ~150° C. to | AC_TR15 |
| | | 0.8 1/h, H₂ 300 nL/L | | | ~300° C. | |
| 8o | A | 348° C., 40 bar, WHSV | −78 | 64.3 | ~100° C. to | AC_TR8o |
| | | 0.8 1/h, H₂ 300 nL/L | | | ~300° C. | |
| 2 | C | 330° C., 40 bar, WHSV | −43 | 33.1 | ~150° C. to | AC_TR2 |
| | | 1.3 1/h, H₂ 360 nL/L | | | ~285° C. | |
| 3 | C | 345° C., 40 bar, WHSV | −57 | 42.9 | ~120° C. to | AC_TR3 |
| | | 1.3 1/h, H₂ 360 nL/L | | | ~285° C. | |
| 1 | D | 330° C., 40 bar, WHSV | −47 | 44.8 | ~100° C. to | AC_TR1 |
| | | 1.3 1/h, H₂ 360 nL/L | | | ~285° C. | |

The hydrocracking catalyst was a non-sulphided bifunctional hydrocracking catalyst comprising Pt on a zeolite/zeolite-type material in all test runs. When the feeds reported in Table 1 were subjected to the hydrocracking conditions reported in Table 2, said catalyst had not only cracking but also isomerizing activity.

The aviation fuel components were recovered in good yields in the test runs.

### Example 2—Physico-Chemical Characteristics of Present Aviation Fuel Components

Physico-chemical characteristics were studied for six aviation fuel components obtained from test runs as reported in Example 1, Table 2, except for AC_TR3′ which was obtained from a similar test run as AC_TR3 but using WHSV 0.6 1/h. A renewable paraffinic jet fuel component obtained by conventional HDO of fatty feedstock and high severity HI process, i.e. without subjecting to hydrocracking, was used as a reference (RRJF). Distillation characteristics are reported in Table 3 and the analyzed values for density, flash point, viscosities at subzero temperatures, and freezing point are reported in Table 4.

TABLE 3
Distillation characteristics of six aviation fuel components (ENISO3405-
2019, except for AC_TR8o ASTM D7345), and yields of said components
presented as wt-% of the degassed HC effluent.

| | | | | | | AC_TR3′ |
|---|---|---|---|---|---|---|
| | AC_TR8 | AC_TR15 | AC_TR8o* | AC_TR1 | AC_TR3 | (WHSV 0.6) |
| Yield, wt-% | 57 | 55 | 64 | 45 | 43 | 56 |
| IBP, ° C. | 176 | 159 | 148 | 137 | 137 | 127 |
| T5, ° C. | 193 | 172 | 165 | 170 | 153 | 151 |
| T10, ° C. | 200 | 177 | 169 | 187 | 162 | 158 |
| T20, ° C. | 215 | 187 | 187 | 218 | 183 | 173 |
| T30, ° C. | 231 | 201 | 208 | 236 | 201 | 187 |
| T40, ° C. | 248 | 217 | 230 | 247 | 219 | 203 |
| T50, ° C. | 261 | 234 | 248 | 253 | 233 | 218 |
| T60, ° C. | 270 | 249 | 264 | 258 | 244 | 232 |
| T70, ° C. | 277 | 262 | 274 | 261 | 251 | 244 |
| T80, ° C. | 281 | 271 | 281 | 264 | 258 | 253 |
| T90, ° C. | 284 | 278 | 285 | 268 | 264 | 261 |
| T95, ° C. | 285 | 280 | 286 | 270 | 267 | 266 |
| FBP, ° C. | 286 | 286 | 287 | 273 | 275 | 270 |
| FBP − IBP, ° C. | 110 | 127 | 139 | 136 | 138 | 143 |
| T90 − T10, ° C. | 84 | 101 | 116 | 81 | 102 | 103 |

*ASTM D7345

TABLE 4
Some physico-chemical characteristics for aviation fuel components from
different test runs, as compared to a reference renewable paraffinic
jet component (RRFJ) obtained by conventional HDO + HI process.

| | | | | | | AC_TR3′ | |
|---|---|---|---|---|---|---|---|
| | AC_TR15 | AC_TR8o | AC_TR1 | AC_TR2 | AC_TR3 | (WHSV 0.6) | RRJF |
| Density at 15° | 768 | 766 | 767 | 767 | 760 | 758 | 772 |
| C. (kg/m³), | | | | | | | |
| ENISO12185- | | | | | | | |
| 1996 | | | | | | | |
| Flash point | 52 | 42 | 42 | 63 | 37 | 33 | 40 |
| (° C.), IP170- | | | | | | | |
| 2013 (Abel | | | | | | | |
| closed-cup | | | | | | | |
| method) | | | | | | | |
| Viscosity −20° | 6.7 | 7.8 | 8.5 | 8.4 | 5.6 | 4.7 | 11.4 |
| C. (mm²/s), | | | | | | | |
| EN ISO | | | | | | | |
| 3104-2020 | | | | | | | |
| Viscosity −40° | 15.9 | 19.7 | 21.5 | 21.4 | 12.7 | 10.6 | 30.5 |
| C. (mm²/s), | | | | | | | |
| EN ISO | | | | | | | |
| 3104-2020 | | | | | | | |
| Freezing | −79.2 | <−80 | n.a. | −61.0 | −69.4 | −77.8 | −49.6 |
| point (° C.), | | | about −60* | | | | |
| ENISO | | | | | | | |
| 13736-2013/ | | | | | | | |
| IP 529-2016 | | | | | | | |

*estimated based on cloud point −69° C.

From Table 3 it can be seen that the distillation characteristics of the recovered aviation fuel components comply with requirements of ASTM D7566-21 Annex A2 for isoparaffinic kerosene obtained from hydroprocessed fatty feedstocks: each of the samples reported in Table 3 have T10 below max. value 205° C., FBP below max. value 300° C., and T90-T10 far greater than 22° C. From the distillation characteristics in Table 3 it can also be seen that the present aviation fuel components have relatively linear distillation behavior, which is beneficial for example for burning characteristics.

From Table 4 it can be seen that the flash points were as required by ASTM D7566-21 Annex A2 (exceeding min value 38° C.), except for the AC-TR3′ component, but this could be easily remedied by slight adjustment of the fractionation procedure. What is more, as the flash points of the other samples clearly exceed the required min. value 38° C. of ASTM D7566-21, by slight adjustment of their fractionation processes more lights (light compounds) could be incorporated in the aviation fuel components thereby further increasing the yields of the components.

Table 4 also shows that density at 15° C. of each of the present aviation fuel components complied with ASTM D7566-21 Annex A2, and was close to the upper limit, max. 772 kg/m³. What is particularly striking in the results reported in Table 4, are the extremely good cold properties of the aviation fuel components according to the present disclosure. Each of the present aviation fuel components reported in Table 4 have very low freezing points, at least 10° C. lower than the freezing point of the reference renewable paraffinic jet fuel component (RRJF). Additionally, even though ASTM D7566-21 Annex A2 for isoparaffinic kerosene obtained from hydroprocessed fatty feedstocks does not set any requirement for viscosities at subzero temperatures, each of the present aviation fuel components reported in Table 4 had very low viscosity at −20° C., some even meeting the ASTM D7566-21 basic requirement for Jet A1 aviation fuel composition, max. 8.0 mm²/s. One of the present samples, AC_TR3′, had very low viscosity even at-40° C., meeting the ASTM D7566-21 extended requirement for Jet A1 aviation fuel composition, max. 12.0 mm²/s.

The above results clearly show that the present aviation fuel components could be incorporated in aviation fuel compositions in far higher proportions than conventional isoparaffinic jet fuel components, as represented e.g. by the reference renewable paraffinic jet fuel component (RRJF). The present aviation fuel components might be incorporated in aviation fuel compositions in amounts of even over 50 vol-% of the total aviation fuel compositions volume. Depending on the development of jet fuel standards, it could also be speculated that suitably additized the present aviation fuel components could be used as 100 vol-% aviation fuel composition in future.

The improved properties of the present aviation fuel components make them advantageous also for other uses where excellent performance in cold environment is required.

### Example 3—Composition of Present Aviation Fuel Components

Three aviation fuel components obtained in Example 1 were analyzed for their compositions by GCxGC-FID/MS. The results of wt-% n-paraffins, mono-branched i-paraffins, and multiple-branched i-paraffins per carbon number in each sample, as well as content of aromatics and naphthenes, are reported in Table 5. Based on the analysis results reported in Table 5, several composition related characteristics were calculated and are reported in Table 6 for the total carbon number range C6-C18, as well as for carbon number ranges C6-C13 and C14-C18, so as to better identify factors possibly contributing to the excellent cold properties discussed in Example 2. Carbon number subranges C6-C13 and C14-C18 were selected for separate evaluation based on estimated freezing points: n-paraffins in subgroup C6-C13 are expected to have freezing points below 0° C. and n-paraffins in subgroup C14-C18 are expected to have freezing points above 0° C.

TABLE 5
Compositional analysis results by GC × GC-FID/GC ×
GC-MS per carbon number for aviation fuel components obtained
from three different test runs of Example 1, Table 2.

| | AC_TR8o (wt-%) | | | AC_TR1 (wt-%) | | | AC_TR2 (wt-%) | | |
|---|---|---|---|---|---|---|---|---|---|
| | | mono- | multi- | | mono- | multi- | | mono- | multi- |
| C# | nP | iP | iP | nP | iP | iP | nP | iP | iP |
| 6 | 0.0 | 0.0 | 0.0 | 0.0 | 0.0 | 0.0 | 0.0 | 0.0 | 0.0 |
| 7 | 0.2 | 0.3 | 0.0 | 0.3 | 0.4 | 0.0 | 0.0 | 0.0 | 0.0 |
| 8 | 1.0 | 3.6 | 0.5 | 0.7 | 1.5 | 0.2 | 0.2 | 0.3 | 0.0 |
| 9 | 0.7 | 4.1 | 1.8 | 0.6 | 2.5 | 0.6 | 0.8 | 2.6 | 0.0 |
| 10 | 0.6 | 3.8 | 2.8 | 0.5 | 2.7 | 1.1 | 0.7 | 3.8 | 0.4 |
| 11 | 0.5 | 3.1 | 3.5 | 0.4 | 2.4 | 1.5 | 0.6 | 3.5 | 1.6 |
| 12 | 0.4 | 2.2 | 3.5 | 0.3 | 2.2 | 2.0 | 0.4 | 2.9 | 2.3 |
| 13 | 0.1 | 1.8 | 3.9 | 0.3 | 2.1 | 2.5 | 0.5 | 3.1 | 2.8 |
| 14 | 0.2 | 1.7 | 5.0 | 0.1 | 2.6 | 4.5 | 0.3 | 3.2 | 3.7 |
| 15 | 0.0 | 0.9 | 2.5 | 0.3 | 3.7 | 11.1 | 0.3 | 4.8 | 4.3 |
| 16 | 0.1 | 0.3 | 2.4 | 0.4 | 7.5 | 30.2 | 0.2 | 8.0 | 12.2 |
| 17 | 0.1 | 0.3 | 5.9 | 0.0 | 2.3 | 10.8 | 0.0 | 0.7 | 24.6 |
| 18 | 0.0 | 0.1 | 39.1 | 0.0 | 0.0 | 0.0 | 0.0 | 0.0 | 9.1 |
| 19 | 0.0 | 0.0 | 0.0 | 0.0 | 0.0 | 0.0 | 0.0 | 0.0 | 0.0 |
| Tot. | 4.1 | 22.2 | 70.9 | 3.8 | 30.1 | 64.5 | 4.0 | 32.9 | 61.2 |

| | | | |
|---|---|---|---|
| Other | Naphthenes 1.8 | Naphthenes 1.4 | Naphthenes 1.8 |
| | Aromatics 0.2 | Aromatics <<0.1 | Aromatics <<0.1 |

TABLE 6
Compositional analysis results by GCxGC-FID/GCxGC-MS calculated
for carbon number ranges C6-C18, C6-C13, and C14-C18, for
the aviation fuel components reported in Table 5.

| | AC_TR8opt | AC_TR1 | AC_TR2 |
|---|---|---|---|
| C6-C18 total P, wt-% | 97.0 | 98.5 | 98.2 |
| C6-C18 nP, wt-% | 4.1 | 3.8 | 4.0 |
| C6-C18 mono-iP, wt-% | 22.2 | 30.1 | 32.9 |
| C6-C18 multi-iP, wt-% | 70.9 | 64.5 | 61.2 |
| C6-C18 multi-iP with ≥3 branches, wt-% | 38.8 | 14.6 | 12.0 |
| C6-C18 total iP, wt-% | 93.1 | 94.5 | 94.2 |
| C6-C18 tot. iP/C6-C18 tot. P, w-ratio | 0.96 | 0.96 | 0.96 |
| C6-C18 tot. iP/C6-C18 nP, w-ratio | 23.9 | 25.0 | 23.5 |
| C6-C18 multi-iP/C6-C18 tot. P, w-ratio | 0.73 | 0.66 | 0.62 |
| C6-C18 multi-iP/C6-C18 nP, w-ratio | 18.2 | 17.1 | 15.3 |
| C6-C18 multi-iP/C6-C18 tot. iP, w-ratio | 0.76 | 0.68 | 0.65 |
| C6-C18 multi-iP/C6-C18 mono-iP, w-ratio | 3.2 | 2.1 | 1.9 |
| C6-C13 total P, wt-% | 38.4 | 24.7 | 30.4 |
| C6-C13 nP, wt-% | 3.5 | 3.0 | 3.3 |
| C6-C13 mono-iP, wt-% | 18.9 | 13.9 | 16.3 |
| C6-C13 multi-iP, wt-% | 16.0 | 7.8 | 10.8 |
| C6-C13 total iP, wt-% | 34.9 | 21.7 | 27.1 |
| C6-C13 tot. iP/C6-C13 tot.P, w-ratio | 0.91 | 0.88 | 0.89 |
| C6-C13 tot. iP/C6-C13 nP, w-ratio | 10.0 | 7.2 | 8.2 |
| C6-C13 multi-iP/C6-C13 tot. P, w-ratio | 0.42 | 0.32 | 0.36 |
| C6-C13 multi-iP/C6-C13 nP, w-ratio | 4.6 | 2.6 | 3.3 |
| C6-C13 multi-iP/C6-C13 tot. iP, w-ratio | 0.46 | 0.36 | 0.40 |
| C6-C13 multi-iP/C6-C13 mono-iP, w-ratio | 0.85 | 0.56 | 0.67 |
| C14-C18 total P, wt-% | 58.6 | 73.5 | 67.8 |
| C14-C18 nP, wt-% | 0.4 | 0.7 | 0.7 |
| C14-C18 mono-iP, wt-% | 3.3 | 16.2 | 16.7 |
| C14-C18 multi-iP, wt-% | 54.9 | 56.6 | 50.4 |
| C14-C18 multi-iP with ≥3 branches, wt-% | 38.0 | 14.5 | 11.7 |
| C14-C18 multi-iP with ≥3 branches/C14- | 0.65 | 0.20 | 0.18 |
| C18 total iP, w-ratio | | | |
| C14-C18 total iP, wt-% | 58.2 | 72.8 | 67.1 |
| C14-C18 tot. iP/C14-C18 tot. P, w-ratio | 0.99 | 0.99 | 0.99 |
| C14-C18 tot. iP/C14-C18 nP, w-ratio | 145.5 | 98.3 | 96.6 |
| C14-C18 multi-iP/C14-C18 tot. P, w-ratio | 0.94 | 0.77 | 0.74 |
| C14-C18 multi-iP/C14-C18 nP, w-ratio | 137.3 | 76.4 | 72.6 |
| C14-C18 multi-iP/C14-C18 tot. IP, w-ratio | 0.94 | 0.78 | 0.75 |
| C14-C18 multi-iP/C14-C18 mono-iP, w- | 16.6 | 3.5 | 3.0 |
| ratio | | | |
| C14-C18 tot.P/C6-C13 tot. P, w-ratio | 1.5 | 3.0 | 2.2 |

In Tables 5 and 6, P refers to paraffins, iP to i-paraffns, nP to n-paraffins, multi-iP to multiple-branched i-paraffins, mono-iP to monobranched i-paraffins,tot. denotes total, and w-ratio denotes weight ratio.

From Table 5 it can be seen that each of the three samples are highly paraffinic with only very low content of naphthenes and aromatics. Table 5 also shows that the most abundant carbon number in AC_TR8o is C18, in AC_TR1 C16, and in AC_TR2 C17. None of the carbon numbers (within detection limit) contained only n-paraffins, but for each carbon number at least mono-and for most carbon numbers also multiple-branched i-paraffins were detected (or even predominant). This proves high isomerization degree throughout the C6-C18 range.

Generally, higher isoparaffin contents tend to improve cold properties of paraffinic hydrocarbon compositions, while n-paraffins generally have the opposite effect, and particularly longer n-paraffins may even solidify when temperature is decreased. From Table 6 it can be seen that each of the three samples had very high C6-C18 i-paraffin contents, 93.1 wt-% or higher. At the same time each of the samples had very low C6-C18 n-paraffin contents, at most 4.1 wt-%. Still the freezing point of AC_TR8o was<−80° C., i.e. below the measurement range of the used method, while samples AC_TR 1 and AC_TR2 had freezing points of about −60° C. (freezing points reported in Table 2). Compared to samples AC_TR 1 and AC_TR2, AC_TR80 had slightly lower content of the longer C14-C18 paraffins, which might contribute to its better cold properties, although all three samples contained more C14-C18 paraffins than C6-C13 paraffins, weight-ratios of C14-C18 to C6-C13 paraffins varying from about 1.5 to about 3.0. Interestingly, AC_TR8o had very high content of multiple-branched C6-C18 i-paraffins (about 71 wt-%), higher than the other samples AC_TR 1 and AC_TR2, and this is believed to have a more pronounced effect on the cold properties. Particularly the high content of C6-C18 multiple-branched isoparaffins with at least three branches, whereof vast majority was in the C14-C18 range, is believed to contribute to the excellent freezing point values of the present aviation fuel components.

Moreover, AC_TR8o had very high isomerization degree particularly among the longer C14-C18 paraffins, as evident from the extremely high weight-ratio of C14-C18 multiple-branched i-paraffins to C14-C18 n-paraffins of about 140, which is almost double compared to samples AC_TR1 and AC_TR2, from the very high weight-ratio of C14-C18 multiple-branched i-paraffins to C14-C18 mono-branched i-paraffins of about 17, which is about 5 times higher compared to samples AC_TR1 and AC_TR2, and from the very high content of C14-C18 multiple-branched isoparaffins with at least three branches, which is about 3 times higher compared ot samples AC_TR1 and AC_TR2.

The isomerization degree among the shorter C6-C13 paraffins was high as well, as evident from the significant content of C6-C13 i-paraffins (from 21.7 to 34.9 wt-%), but here the contents of mono-branched i-paraffins were somewhat higher than contents of multiple-branched i-paraffins. This can be explained by shorter chains having less room for side chains. Nevertheless, each of the samples studied in Tables 5 and 6 had high content of C6-C13 multiple-branched i-paraffins (from 7.8 to 16.0 wt-%), high weight-ratios of C6-C13 total i-paraffins to C6-C13 n-paraffins (from 7.2 to 10.0), and even high weight ratios of C6-C13 multiple-branched i-paraffins to C6-C13 n-paraffins (from 2.6 to 4.6).

Based on their cold properties, distillation characteristics, high paraffinicity, and very high isomerization degree, the present aviation fuel components is believed to have desired properties also for a wide range of other uses than in aviation fuels, such as in solvent(s), in carrier(s), in dispersant composition(s), in demulsifier(s), in extractant(s), in detergent(s), in degreasing composition(s), in cleaner(s), in thinner(s), in penetrating oil(s), in anticorrosion composition(s), in multipurpose oil(s), in metal working fluid(s), in rolling oil(s) especially for aluminium, in cutting oil(s), in drilling fluid(s), in lubricant(s), in extender oil(s), in paint composition(s), in coating fluid(s) or paste(s), in adhesive(s), in resin(s), in varnish(es), in printing paste(s) or ink(s), in plasticizing oil(s), in turbine oil(s), in hydrophobization composition(s), in agriculture, in crop protection fluid(s), in construction, in concrete demoulding formulation(s), in electronic(s), in medical appliance(s), in feedstock(s) for industrial conversion process(es), preferably in thermal cracking feedstock(s) and/or in catalytic cracking feedstock(s), in composition(s) for car, electrical, textile, packaging, paper and/or pharmaceutical industry, and/or in manufacture of intermediate(s) therefor.

Various embodiments have been presented. It should be appreciated that in this document, words comprise, include, and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1-23. (canceled)

24. An aviation fuel component, comprising:
n-paraffins, monobranched i-paraffins and multiple-branched i-paraffins, wherein:
a sum amount of C6-C18 n-paraffins, C6-C18 monobranched i-paraffins, and C6-C18 multiple-branched i-paraffins is at least 90 wt-%, and/or at least 93 wt-%, and/or at least 95 wt-%, and/or at least 96 wt-% of a total aviation fuel component weight; and wherein:
a weight ratio of C6-C18 multiple-branched i-paraffins to C6-C18 n-paraffins is at least 11; and wherein:
the aviation fuel component has T10 and T90 temperatures, as determined according to EN ISO 3405-2019, within a range from 120° C. to 295° C., and/or within a range from 130° C. to 295° C.

25. The aviation fuel component according to claim 24, wherein the sum amount of C6-C18 monobranched i-paraffins, and C6-C18 multiple-branched i-paraffins is at least 85 wt-%, and/or at least 87 wt-%, and/or at least 90 wt-%, and/or at least 92 wt-% of the total aviation fuel component weight; and/or the amount of C6-C18 multiple-branched i-paraffins is at least 58 wt-%, and/or at least 60 wt-%, and/or at least 62 wt-% of the total aviation fuel component weight.

26. The aviation fuel component according to claim 24, wherein the weight ratio of C6-C18 multiple-branched i-paraffins to C6-C18 n-paraffins is at least 12, and/or at least 14, and/or at least 16; and/or the weight ratio of C6-C18 multiple-branched i-paraffins to C6-C18 mono-branched i-paraffins is at least 1.6, and/or at least 1.7, and/or at least 1.8, and/or at least 1.9.

27. The aviation fuel component according to claim 24, wherein a weight ratio of C14-C18 multiple-branched i-paraffins to C14-C18 n-paraffins is more than 20, and/or at least 30, and/or at least 40, and/or at least 50; and/or
the weight ratio of C14-C18 multiple-branched i-paraffins to C14-C18 mono-branched i-paraffins is more than 2.0, and/or at least 2.4, and/or at least 2.6, and/or at least 2.8; and/or the weight-ratio of C14-C18 multiple-branched i-paraffins with at least three branches to C14-C18 total i-paraffins is at least 0.10, and/or at least 0.12, and/or at least 0.15, and/or at least 0.17; and/or the amount of C14-C18 multiple-branched i-paraffins is at least 35 wt-%, and/or at least 40 wt-%, and/or at least 45 wt-%, and/or at least 50 wt-% of the total aviation fuel component weight; and/or
the amount of C14-C18 multiple-branched i-paraffins with at least three branches is at least 5 wt-%, and/or at least 8 wt-%, and/or at least 10 wt-%, and/or at least 12 wt-% of the total aviation fuel component weight.

28. The aviation fuel component according to claim 24, wherein an amount of C6-C13 multiple-branched i-paraffins is at least 5.0 wt-%, and/or at least 7.0 wt-%, and/or at least 8.0 wt-%, and/or at least 9.0 wt-% of the total aviation fuel component weight.

29. The aviation fuel component according to claim 24, wherein a weight ratio of C14-C18 total paraffins to C6-C13 total paraffins is within a range from 0.8 to 5.0, and/or from 1.0 to 4.5, and/or from 1.1 to 4.0, and/or from 1.2 to 3.5.

30. The aviation fuel component according to claim 24, wherein a carbon number distribution of the paraffins in the present aviation fuel component covers at least six adjacent carbon numbers, and/or at least seven adjacent carbon numbers, and/or at least eight or at least nine adjacent carbon numbers, within the C6-C18 range.

31. The aviation fuel component according to claim 24, wherein the difference between T90 and T10 temperatures, as determined according to EN ISO 3405-2019, is at least 70° C., and/or at least 75° C., and/or at least 80° C., and/or at least 85° C.

32. The aviation fuel component according to claim 24, having a T90 temperature of at least 250° C., and/or at least 255° C., optionally at most 295° C., and/or within a range from 250° C. to 295° C., as determined according to EN ISO 3405-2019, and optionally having a final boiling point (FBP) at most 300° C., and/or at least 270° C., and/or within a range from 270° C. to 300° C., as determined according to EN ISO 3405-2019.

33. The aviation fuel component according to claim 24, wherein a ratio of difference between T50 and T5 temperatures to difference between T95 and T50 temperatures (T50−T5)/(T95−T50) is within a range from 0.7 to 6.0, and/or from 0.8 to 5.5.

34. The aviation fuel component according to claim 24, having a kinematic viscosity at −20° C. as determined according to EN ISO 3104-2020 within a range from 4.0 mm²/s to 10.0 mm²/s, and/or from 4.0 mm²/s to 9.5 mm²/s, and/or from 4.0 mm²/s to 8.5 mm²/s; and/or having a kinematic viscosity at −40° C. as determined according to EN ISO 3104-2020, within a range from 9.0 mm²/s to 30.0 mm²/s, and/or from 10.0 mm²/s to 28.0 mm²/s, and/or from 10.0 mm²/s to 25.0 mm²/s.

35. The aviation fuel component according to claim 24, having a flash point as determined according to IP 170-2013 (Abel closed-cup method) of at least 38° C.

36. The aviation fuel component according to claim 24, having a freezing point as determined according to IP 529-2016 of −40° C. or less, and/or −50° C. or less, more and/or −60° C. or less.

37. The aviation fuel component according to claim 24, having density at 15° C. as determined according to EN ISO 12185-1996 within a range from 750 kg/m³ to 780 kg/m³, and/or from 750 kg/m³ to 775 kg/m³, and/or from 750 kg/m³ to 772 kg/m³.

38. The aviation fuel component according to claim 24, having a biogenic carbon content, as determined according to EN 16640 (2017), of at least 50 wt-%, and/or at least 70 wt-%, and/or at least 90 wt-% based on a total weight of carbon (TC) in the aviation fuel component.

39. The aviation fuel component according to claim 24, obtained by a process comprising:
providing a paraffinic hydrocarbon feed, obtained by hydrodeoxygenation of an oxygenated hydrocarbon feed including vegetable oils, animal fats, and/or microbial oils and optionally followed by gas-liquid separation and/or paraffinic feed fractionation(s); and
subjecting the paraffinic hydrocarbon feed to at least hydroisomerisation, and/or to hydroisomerisation and hydrocracking, followed by fractionation, and recovering from the fractionation at least the aviation fuel component.

40. The aviation fuel component according to claim 24, obtained by a process comprising:
providing a paraffinic hydrocarbon feed including at least 60 wt-% paraffins of a total weight of the paraffinic hydrocarbon feed, of which paraffins at most 30 wt-% are i-paraffins;
subjecting the paraffinic hydrocarbon feed in a first reaction section, in a first reactor, to hydroisomerisation in a presence of a hydroisomerisation catalyst to obtain a hydroisomerisation effluent;
subjecting a second reaction section feed including at least a portion of the hydroisomerisation effluent to hydrocracking in a second reaction section, in a second reactor, in a presence of a hydrocracking catalyst to obtain a hydrocracking effluent; and
subjecting the hydrocracking effluent, and optionally a portion of the hydroisomerisation effluent, to fractionation, and recovering from the fractionation at least the aviation fuel component, and optionally a gasoline fuel component and/or a diesel fuel component.

41. The aviation fuel component according to claim 24, in an aviation fuel composition for improving one or more product properties of the aviation fuel composition, wherein said one or more product properties of the aviation fuel composition comprises at least one or more of kinematic viscosity at −20° C., kinematic viscosity at −40° C., freezing point, density, and/or biogenic carbon content.

42. The aviation fuel component according to claim 24 in solvent(s), in carrier(s), in dispersant composition(s), in demulsifier(s), in extractant(s), in detergent(s), in degreasing composition(s), in cleaner(s), in thinner(s), in penetrating oil(s), in anticorrosion composition(s), in multipurpose oil(s), in metal working fluid(s), in rolling oil(s) especially for aluminum, in cutting oil(s), in drilling fluid(s), in lubricant(s), in extender oil(s), in paint composition(s), in coating fluid(s) or paste(s), in adhesive(s), in resin(s), in varnish(es), in printing paste(s) or ink(s), in plasticizing oil(s), in turbine oil(s), in hydrophobization composition(s), in agriculture, in crop protection fluid(s), in construction, in concrete demoulding formulation(s), in electronics, in medical appliance(s), in feedstock(s) for industrial conversion process(es), in thermal cracking feedstock(s) and/or in catalytic cracking feedstock(s), in composition(s) for car, electrical, textile, packaging, paper and/or pharmaceutical industry, and/or in manufacture of intermediate(s) therefor.

43. The aviation fuel component according to claim 24, wherein the aviation fuel component is additized with at least one or more of antioxidant(s), electrical conductivity additive(s), stabilizer(s), detergent(s), corrosion inhibitor(s), friction modifier(s), metal deactivator(s), lubricating additive(s), antifoaming agent(s), and/or fuel dye(s).

44. The aviation fuel component according to claim 24, having a carbon number distribution of the paraffins covering at least six adjacent carbon numbers, and/or at least seven adjacent carbon numbers, and/or at least eight or at least nine adjacent carbon numbers, within a C6-C18 range.

45. An aviation fuel composition comprising:
the aviation fuel component according to claim 24; and/or
wherein the aviation fuel composition fulfills requirements for aviation fuels set in ASTM D7566-21 Table 1; and/or
wherein said aviation fuel composition includes the aviation fuel component in an amount from 1 to 99.5 vol-%, and/or from 5 to 95 vol-%, and/or from 10 to 70 vol-% of a total aviation fuel composition volume.
